(19) United States
(12) Patent Application Publication
(10) Pub. No.: US 2004/0103067 A1
(43) Pub. Date: May 27, 2004

(54) Metering funds debit and credit for multi use

(76) Inventors: James M. Mattern, Bethany, CT (US); George Brookner, Norwalk, CT (US)

Correspondence Address: PERMAN & GREEN, 425 POST ROAD, FAIRFIELD, CT, 06824, US

(21) Appl. No.: 10/356,300

(22) Filed: Jan. 31, 2003

Related U.S. Application Data
(60) Provisional application No. 60/429,452, filed on Nov. 26, 2002.

(51) Int. Cl. G06F 17/00

(52) U.S. Cl. 705/401; 705/402

(57) ABSTRACT

A method and system for using a postal meter to pay for services other than postage. This can include funding the postal meter from a postal data center, establishing a communication channel between the postal meter and a host server, accessing a services/products purchase menu through the host server, selecting one or more services/products for purchase, debiting funds from the postal meter for the services/product purchased, adjusting a postal account associated with the postal meter with the funds debited from the postal meter for the services/product purchase, and reallocating the recredited funds to an account associated with the services/products purchased.

### CROSS-REFERENCE TO RELATED APPLICATIONS

This application claims priority from U.S. Provisional Application No. 60/429,452, filed Nov. 25, 2002.

### BACKGROUND OF THE INVENTION

1. Field of the Invention

The present invention is generally related to the use of funds in a postal meter, and in particular to the use of funds stored in a postal meter for services other than proof of postage.

2. Brief Description of Related Developments

It is well known to use postal meters for payment for proof of postage. Examples of postage meters or franking systems are illustrated in U.S. Pat. Nos. 5,200,903 and 6,009,417, the disclosures of which are incorporated herein by reference in their entireties. Generally, the funds, or money, that are credited to a postal meter for proof of postage is owned by the United States Postal Service (“USPS”) or other such authority. Thus, it is not presently possible to use those funds for something other than postage. In ordinary practice, the user of a postage meter will make arrangements with the owner or vendor of the postage meter or other certified authority, such as for example, Neopost, to deposit funds that will then be credited or allocated to the postage meter. Then the “meter” will have these funds available to be used for proof of postage.

In the United States, a postal customer generally may add postage to the meter in two ways. The first is to physically take the meter to the postal authority, generally referred to herein as “the post,” where postage is purchased and added to the PSD. The second is to remotely add postage over a network, for example, a telephone line with a modem, or the Internet, where the added postage is deducted from an account usually maintained with a meter vendor or a trusted third party administrator, for example, a financial institution. In this case, customer or postal authority access to a meter's accounting system or memory system generally is not possible. Meters with this type of communication capability may initiate communication with a host computer to add funds or to reestablish authenticity. A communication cycle may be initiated automatically, or by a user of the meter.

A postal security device (“PSD”) can be used to contain information maintained in postage meters related to the available funds. The information can be maintained and accounted for, in for example ascending and descending registers in the PSD. An example of a PSD is illustrated in U.S. Pat. No. 6,041,317, the disclosure of which is incorporated herein in its entirety. Current postal or postage meters are not adapted to allow for use of the funds credited to the postage meter for anything other than proof of postage. It would be helpful to allow for use of the funds credited or allocated to a postage meter for services other than proof of postage.

For example, in many instances, a user of a postage meter or meters, will deposit a sum of money with the USPS or other authorized vendor, the value of which is to be credited or allocated to an associated postage meter or meters. The funds are retained in the postage meter until the funds are expended for proof of postage. However, at times it may be necessary or desirable to update the postage meter with different files or service upgrades, such as for example rate upgrades, upgraded or new levels of service, new or different logos or messages, or other files or services that are associated with postage meters. Each of these services, although associated with the postage meter, generally requires an additional fee that up until now, could not be paid for using the funds that are stored or deposited in the postage meter by the customer. A separate payment method for the additional service, such as for example a check, credit card or other invoicing, had to be utilized. This can seem unnecessary or redundant when there are ample funds already on deposit or stored in the postage meter. Thus, it would be advantageous to be able to utilize the funds or money on deposit or “held” within the registers of the postage meter, such as the PSD, to pay for additional or other services and/or products that are needed or desired.

### SUMMARY OF THE INVENTION

The present invention is directed to a method for using method a postal meter to pay for services other than postage. In one embodiment the method comprises funding the postal meter from a postal data center, establishing a communication channel between the postal meter and a host server, accessing a services/products purchase menu through the host server, selecting one or more services/products for purchase, debiting funds from the postal meter for the services/product purchased, adjusting a postal account associated with the postal meter with the funds debited from the postal meter for the services/product purchase, reallocating the recredited funds to an account associated with the services/products purchased.

In one aspect, the present invention is directed to a system for using funds stored in a postal metering system for other paid for services. In one embodiment the system comprises a meter system, a data center adapted to communicate with the metering system, a product/services ordering system adapted to communicate with the data center and allow a user to communicate with the meter system to request payment for services provided by the product/services ordering system, which payment is deducted from the meter system and an account associated with the meter system is adjusted for the funds debited from the metering system for the purchase.

In a further aspect, the present invention is directed to a computer program product. In one embodiment, the computer program product comprises a computer usable medium having computer readable code means embodied therein for causing a computer to use a postal meter to pay for services other than postage. The computer readable code means and the computer program product comprises computer readable program code means for causing a computer to fund the postal meter from a postal data center, establish a communication channel between the postal meter and a host server, access a services/product purchase menu through the host server, select one or more services/products for purchase, debit fund from the postal meter for the services/product purchased, adjust a postal account associated with the postal meter with the funds debited from the postal meter for the services/product purchase, and reallocate the recredited funds to an account associated with the services/products purchased.

### BRIEF DESCRIPTION OF THE DRAWINGS

The foregoing aspects and other features of the present invention are explained in the following description, taken in connection with the accompanying drawings, wherein:

FIG. 1 is a block diagram of an exemplary metering system incorporating features of the present invention.

FIG. 2 is a block diagram of another embodiment of a metering system incorporating features of the present invention.

FIG. 3 is a block diagram of another embodiment of a metering system incorporating features of the present invention using separate vaults.

FIG. 4 is a flow chart illustrating one embodiment of a method incorporating features of the present invention.

FIG. 5 is a block diagram of a typical apparatus that may be used to practice the present invention.

### DETAILED DESCRIPTION OF THE PREFERRED EMBODIMENT(S)

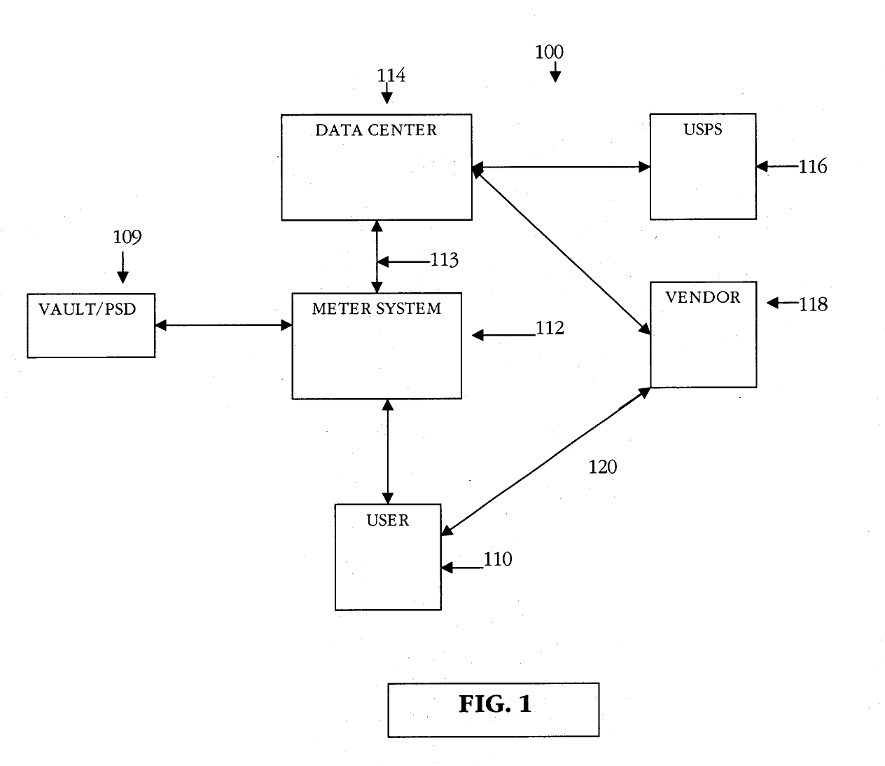

FIG. 1 is a block diagram of an exemplary system that can be implemented to use funds stored in a postage meter for services/products other than proof of postage. The term “funds” as used herein generally refers to any item that has an associated monetary value that can be used to pay for a service and/or product. This can include a cash payment, credit, debit or other accounting system.

As illustrated in FIG. 1 the system 100 generally includes a postage or postal meter 112 and an associated data center 114. The data center 114 is adapted to communicate with an associated service vendor or certified authority 116, such as for example the USPS. The data center can also be adapted to communicate with a vendor 118. The vendor 118 can include a certified authority or such other entity that generally provides services and/or products that are related to the postage meter, the postal system, or the general processing and movement of mail through a mail system. Although the postal and mail are used herein, the use of the present invention is not limited to the USPS and can be applied in any system that processes items for transport and deliver, such as for example a courier service or other document transportation system. The user 110 generally communicates with the meter 112 to request payment for postage or other services and updating or replenishing the funds in the meter 112.

The meter 112 can comprise a conventional postage meter, or another suitable device for generating postage indicia, proof of payment indicia or other evidence of monetary value, such as for example the system described in U.S. Pat. No. 6,041,317. For example, the meter 112 can include a personal computer system that is adapted to securely generate evidence of payment, such as indicia, coupon, ticket, or such other suitable medium which represents proof of payment. The metering system 112 can also include a built-in printer or an add-on printer, as well as a suitable user interface and display means. (not shown).

The meter 112 can also include a postal security device 109. The PSD 109 generally contains information representative of the information related to funds maintained in or allocated to postage meters, such as for example ascending and descending registers. This information is used by the PSD 109 in the creation of postal indicia or other proof of payment indicia. The meter system 112 is capable of communicating with the Data Center 114 which in turn is capable of communicating with a suitable postal authority 116, their financial institution or other certification authority. The meter system 112 is also capable of communicating with a customer or user 110, such that customers may provide user inputs, such as requesting additional funds, which may be used by the meter 112 in concert with the PSD 109 to create the required indicia.

Preferably PSD 109 is a cryptographically secure PSD, such as that described in PCT Application No. PCT/US97/15856, now PCT publication no. WO 98/20461, filed on Nov. 7, 1997, entitled “SYSTEM FOR PROTECTING CRYPTOGRAPHIC PROCESSING AND MEMORY RESOURCES FOR POSTAL FRANKING MACHINES” the disclosure of which is hereby incorporated herein by reference in its entirety. Accordingly, all communication with the PSD 109 outside of the cryptographic boundary established by the PSD 109 is encrypted, including communications with data center 119 and authority 116.

The PSD 109 and meter system 112 generally allows for the interchange of data between a funds provider source, a computational funds tracking and maintenance source and a printing source. The present invention generally provides the customer with the ability to optimize the customer's use, tracking and replenishment of the customer's franking funds within the environment surrounding the dispensing of funds stored in the meter for proof of payment for the services required. In one embodiment, the PSD 109 can be part of an open system where the proof of payment for services printing means is external to the system computational means or alternatively, a closed system where the proof of payment printing means are housed within the system computational means. Examples of such systems are disclosed in U.S. Pat. No. 6,009,417.

As shown in FIG. 1, metering system 112 couples to the data center or host 114 via a communications link 113, which can be a wireline or wireless link, secure or unsecured link. This can include for example a direct connection, a dial-up connection, a modem, or a network or Internet connection. In alternate embodiments, any suitable communication means or method can be utilized. For example, communications link 113 can be a standard serial or parallel interface and may employ any mechanism for transferring information, such as an RS-232C serial communications link. To provide a secure communications link that resists unauthorized interception, data can be encrypted, encoded, or signed before being sent over the communications link. Similar communication links can be established between the meter 112, PSD 109, user 110, and the USPS 116 and vendor 118. The links can be any suitable communication means, including for example, a modem, a network or Internet connection or a wireless connection.

The meter system 112 can be set with postal funds via its associated data center 114 using processes and procedures well known in the industry, such as for example Neoposts' EPOC or TMS systems. The present invention allows the meter funds originally allocated for postage and typically represented as value in the descending register, to be removed and credited or allocated to other paid-for services/products. Thus, the meter holding postal funds may be the source for customer funds to pay for services other than proof of postage.

In one embodiment, referring to FIG. 1, the customer 110 can order services or product from a vendor 118.

The services/products could be ordered directly from the vendor 118, via for example a telephone call or on-line ordering network in which case, that request could occur over a suitable communication link 120. Alternatively, the request or order for service/product could be made through the meter system 112, and the data center 114. It is a feature of the present invention to be able to order a product(s) or service(s), that is not postage, yet pay for the product/service from funds stored or credited to the postage meter.

An example of such a service or product would be the purchase of a rate upgrade for the postage meter 112. Although the present invention is generally described as being used for purchasing products/services related to postal service, the scope of the present invention is not so limited and any service/product that is available to be purchased via an “on-line” ordering system can be encompassed. For example, the system could be used to purchase items available over a network, such as for example the Internet. Generally, rate upgrade data is purchased when postage rates are changed by a postal authority and supplied by the vendor associated with the meter 112, such as for example NEOPOST. When the user or customer 110 wishes to upgrade the meter 112 and purchase the rate upgrade, separate payment arrangements must be made other than using the funds stored in the meter 112. The present invention allows the payment for the services/product, such as new postal rates, to be in essence “deducted” from the meter 112 and “credited” or “reallocated” to the vendor 118 who provide the new rates or rate upgrades.

Accounting between the meter 112, the associated data center 114, the USPS 116 or financial institution and the vendor 118 will accommodate the reallocation of the funds debited from the meter 112 for services/products other than proof of postage. An example of this is as follows. A customer may originally deposit $100,000. to be used for postage (proof of payment of postage). This amount will then be reflected in the associated postage meter and the corresponding account related to the USPS. If the customer wishes to use $10,000. for a service (product other than proof of postage), the amount of $10,000. is taken from the meter account and transmitted or paid to the vendor of the service. The USPS account must be credited to reflect the alternate use of the $10,000. So the USPS account is updated to show that the $10,000. has been reallocated. If the balance of the USPS account was $100,000. prior to the reallocation, the. remaining balance available for postage will now be $90,000.

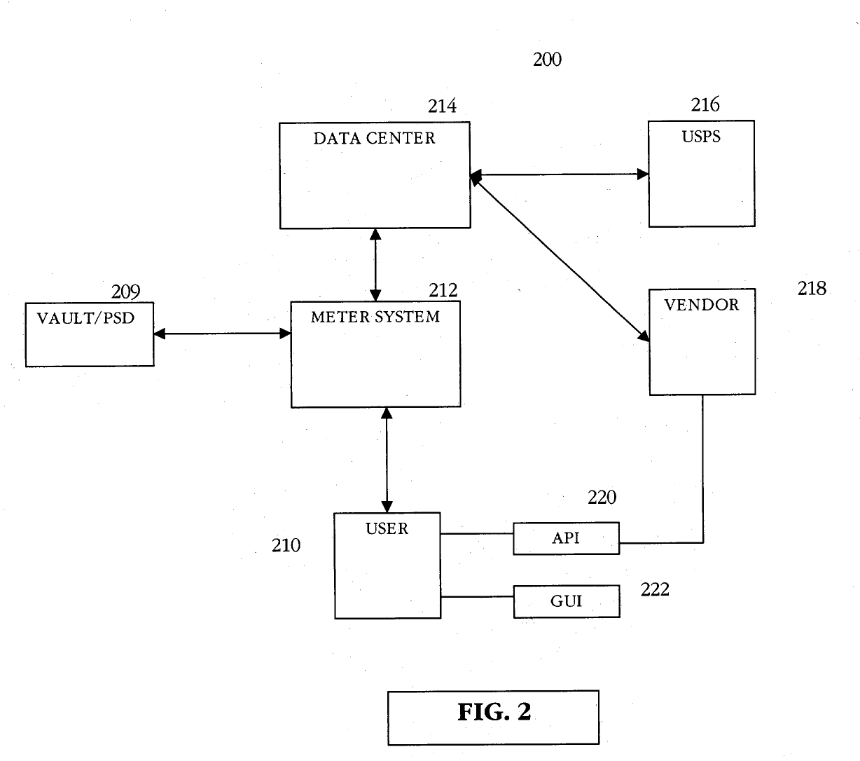

Referring to FIG. 2, another embodiment of a system incorporating features of the present invention as illustrated. The system 200 includes an application program interface 220 and a graphical user interface 222. The API 220 and GUI 222 can allow the user 210 to interface with the meter system 212 as well as the vendor 218. In this way, the user can interface essentially directly with the vendor to order the additional services and/or products, the funds for which would then be debited from the meter system as previously described.

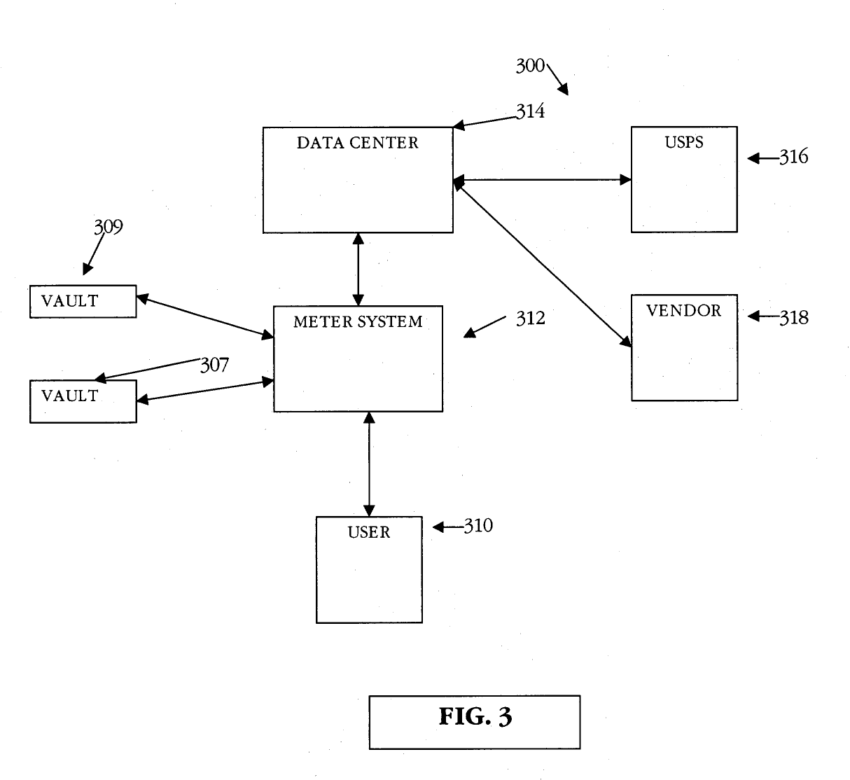

FIG. 3 is illustrative of another embodiment of a system incorporating features of the present invention. As shown in FIG. 3, the meter system 312 utilized two vaults or PSD's 307, 309. In this embodiment, the vault 309 could include funds that are dedicated to the USPS 316, while the vault 307 could be utilized for other paid-for services, such as for example, those purchased through vendor 318. In this manner, funds dedicated to the USPS 316 are not commingled with funds that can be used for other services or products.

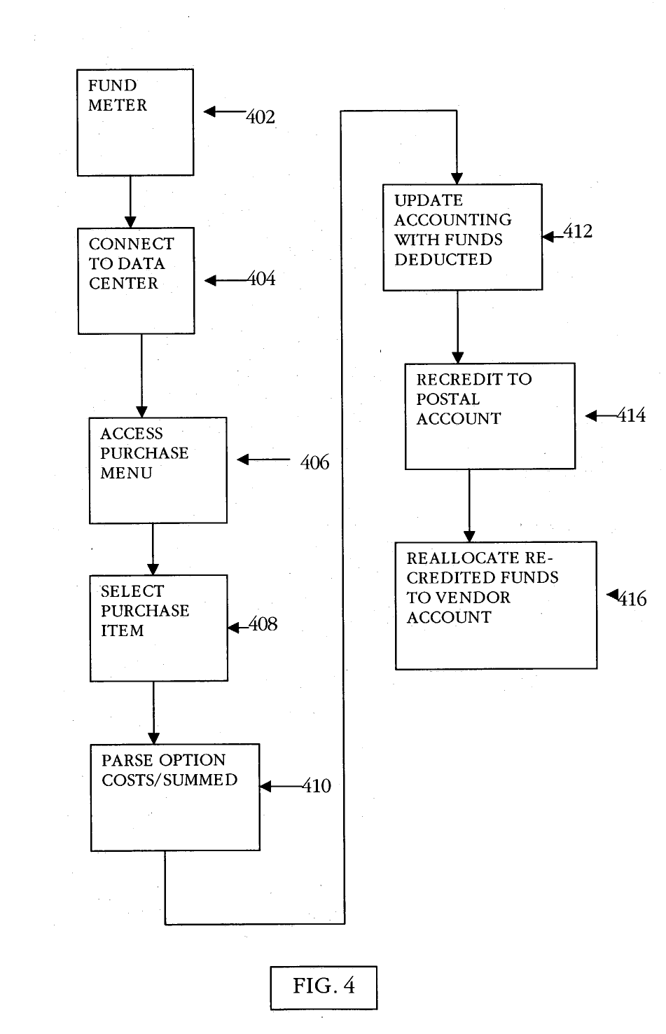

For example, in one embodiment, referring to FIG. 4, a method of using funds in a postage meter for payment for services other than postage is illustrated. The meter is funded in step 402. This can include receiving funds via the data center 114 of FIG. 1 using said postal service approved data center 114 methodology. The meter 112 will connect to its host server, in step 404, which in FIG. 1 is the data center 114 to access a “services/product purchase” menu in step 406. This can include connecting to the vendor 118 of FIG. 1 to determine or identify the product(s)/service(s) to purchase and the amount of funds required, which can then be deducted from the meter. In one embodiment the meter 112 can include an existing menu that can be updated by floppy disk, ROM chip, download or such other suitable means. The user 110 can then, in step 408, select one or more services from the menu. In one embodiment, referring to FIG. 2, the services can be presented to the customer 210 through one or more application program interfaces 220 and graphical user interfaces 222. In step 410, the option costs are parsed and summed, the term “option” referring to the particular products/services selected. Double accounting in the meter 112 and data center 114 may be desirable, although not necessary. Cryptographic security, authentication and validation per published Public Key Infrastructure (“PKI”) is the preferred embodiment for the protection of funds transfers as well as confidentiality and security of the funds as well a customer-related data.

In step 412 the meter 112 updates its accounting with the amount of funds deducted. Rather than deducting funds for postage spent, in this case the funds are deducted for the service or product purchased.

In step 414, the data center 114 re-credits the customer's postal account with the USPS 116 or financial institution with the meter's debited funds and in step 416, re-allocates those funds just re-credited to the customer's postal account to the service or product providers account, or other accounting means to reconcile the money in question (i.e. checking account, debit or invoicing for example). Therefore, the customers total account balance is reduced by the amount paid for the purchased options while the postal account is credited accordingly. For example, if the. USPS or financial institution account related reflects $100,000. allocated for postage, that account must now be updated to reflect that a portion of those funds were used for something other than postage. Thus, the USPS related account is updated to reflect the amount available for postage.

In one embodiment, the user could order a service/product from a vendor and authorize the vendor to obtain payment from the meter. An authorization code could be provided. The vendor would contact the data center, provide the payment information, and the data center would transfer the necessary funds from the meter. The user could also indicate via the meter that an amount is to be deducted from the meter for other than postage. The user could input the necessary data to the meter which is communicated to the data center. The data center communicates with the vendor and arranges to transfer the required funds and reconcile the accounts. The vendor could be part of an on-line network such as the Internet. The data center or user could also cause the meter to print a receipt or other suitable medium as proof of payment for the service/product. The proof of payment could bear an indicia or other indication of authenticity. The proof of payment could be communicated or presented to the vendor as payment or evidence of payment. The vendor could transmit the indicia to the data center to verify the authenticity of the presented payment.

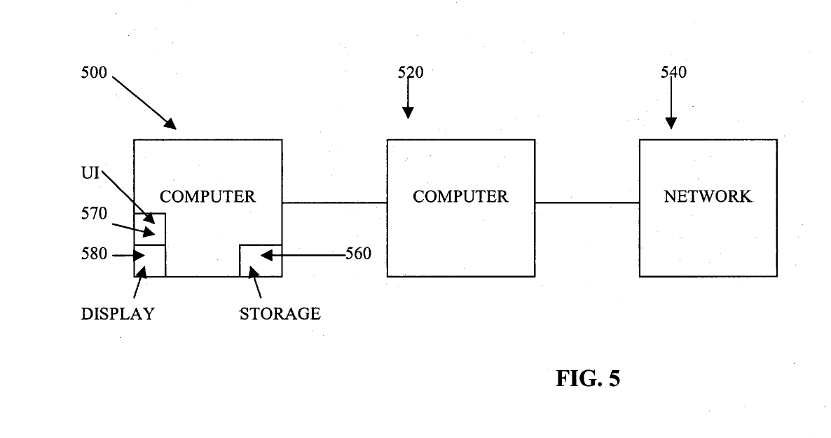

The present invention may also include software and computer programs incorporating the process steps and instructions described above that are executed in different computers. In the preferred embodiment, the computers are connected to the Internet. FIG. 5 is a block diagram of one embodiment of a typical apparatus incorporating features of the present invention that may be used to practice the present invention. As shown, a computer system 500 may be linked to another computer system 520, such that the computers 500 and 520 are capable of sending information to each other and receiving information from each other. In one embodiment, computer system 520 could include a server computer adapted to communicate with a network 540, such as for example, the Internet. Computer systems 500 and 520 can be linked together in any conventional manner including a modem, hard wire connection, or fiber optic link. Generally,, information can be made available to both computer systems 500 and 520 using a communication protocol typically sent over a communication channel or through a dial-up connection or ISDN line. Computers 500 and 520 are generally adapted to utilize program storage devices embodying machine readable program source code which is adapted to cause the computers 500 and 520 to perform the method steps of the present invention. The program storage devices incorporating features of the present invention may be devised, made and used as a component of a machine utilizing optics, magnetic properties and/or electronics to perform the procedures and methods of the present invention. In alternate embodiments, the program storage devices may include magnetic media such as a diskette or computer hard drive, which is readable and executable by a computer. In other alternate embodiments, the program storage devices could include optical disks, read-only-memory (“ROM”) floppy disks and semiconductor materials and chips.

Computer systems 500 and 520 may also include a microprocessor for executing stored programs. Computer 500 may include a data storage device 560 on its program storage device for the storage of information and data. The computer program or software incorporating the processes and method steps incorporating features of the present invention may be stored in one or more computers 500 and 520 on an otherwise conventional program storage device. In one embodiment, computer 500 may include a user interface 570 and a display interface 580 from which features of the present invention can be accessed. Similar features might be found associated with computer 520. The user interface 570 and the display interface 580 can be adapted to allow the input of queries and commands to the system, as well as present the results of the commands and queries.

Generally, the present invention allows meter funds to be removed and credited to other paid for services. The meter, which can comprise a postal meter holding funds, may be the source for a customer using funds to pay for services other than proof of postage. It is understood that postage funds in the meter are not to be used for other than proof of postage payment, and it is further understood that the postal funds account is adjusted accordingly to assure funds for postage are not debited for other than proof of postage payment.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

What is claimed is:

1. A method for using a postal meter to pay for services other than postage comprising the steps of:
funding the postal meter from a postal data center;
establishing a communication channel between the postal meter and a host server;
accessing a services/products purchase menu through the host server;
selecting one or more services/products for purchase;
debiting funds from the postal meter for the services/product purchased;
adjusting a postal account associated with the postal meter with the funds debited from the postal meter for the services/product purchase; and
reallocating the recredited funds to an account associated with the services/products purchased.

2. The method of claim 1 wherein the postal meter includes a postal security device and funds are credited to and debited from the postal security device.

3. The method of claim 2 wherein the postal security device includes a vault adapted to be a source of funds for proof of postage and is adjusted accordingly to accommodate payment for services/products other than proof of postage

4. The method of claim 2 wherein the postal security device includes at least a first vault and a second vault, the first vault adapted to be a source of funds for proof of postage and the second vault adapted to be a source of funds for services/products other than proof of postage.

5. The method of claim 1 wherein the step of selecting further comprising selecting one or more services/products to be purchased from a menu via a graphical user interface.

6. The method of claim 1 wherein the data center is adapted to reconcile the postal account associated with the postal meter to reflect the funds debited from the postal meter and adjust a balance remaining for postage, while allocating the funds for the purchase to the account associated with the purchase.

7. The method of claim 1 further comprising printing a proof of payment for the services/products purchased from the postal meter.

8. The method of claim 1 further comprising generating a voucher on which is printed by the postal meter an indicia that is redeemable for the services/product purchased.

9. The method of claim 1 wherein the host server is the data center.

10. The method of claim 1 wherein the host server is adapted to establish a connection with the Internet and the services/products purchase menu represents an on-line connection with a vendor on the Internet, the services/products purchase menu representing items available from the vendor for purchase.

11. A system for using funds stored in a postal metering system for other paid for services comprising:
a meter system;
a data center adapted to communicate with the metering system; and
a product/services ordering system adapted to communicate with the data center and allow a user to communicate with the meter system to request payment for services provided by the product/services ordering system, which payment is deducted from the meter system and an account associated with the meter system is adjusted for the funds debited from the metering system for the purchase.

12. The system of claim 11 wherein the meter system includes a postal security device.

13. The, system of claim 11 wherein the meter system includes a first postal security device for storing funds related to postal services and a second postal security device for storing funds related to other paid for services.

14. The system of claim 11 wherein the product/services ordering system comprises an on-line ordering network and the data center is adapted to connect to a specific vendor associated with the network and allow the vendor to request payment from the data center for a purchase made by the user.

15. The system of claim 14 wherein the data center further includes an accounting system adapted to reconcile an amount of funds indicated as on deposit with an account associated with a postal service for postage, an amount of funds available in the postage meter and funds used for the purchase.

16. The system of claim 11 wherein the meter is adapted to provide a selection to the user to select a payment option for proof of postage or payment for other services/products.

17. The system of claim 16 wherein the meter is adapted to print a proof of payment indicia for the service/product ordered, wherein the indicia can be presented to the vendor as payment.

18. The system of claim 17 wherein the vendor is adapted to communicate the indicia on the printed proof of payment to the data center for verification.

19. The system of claim 11 wherein the meter further includes a user interface adapted to allow the user to communicate with the meter for ordering proof of postage and also communicate with the data center for at least authorizing payment for services/products other than proof of postage that are paid for from funds in the meter.

20. A computer program product comprising:
a computer useable medium having computer readable code means embodied therein for causing a computer to a postal meter to pay for services other than postage, the computer readable code means in the computer program product comprising:
computer readable program code means for causing a computer to fund the postal meter from a postal data center;
computer readable program code means for causing a computer to establish a communication channel between the postal meter and a host server;
computer readable program code means for causing a computer to access a services/products purchase menu through the host server;
computer readable program code means for causing a computer to select one or more services/products for purchase;
computer readable program code means for causing a computer to debit funds from the postal meter for the services/product purchased;
computer readable program code means for causing a computer to adjust a postal account associated with the postal meter with the funds debited from the postal meter for the services/product purchase; and
computer readable program code means for causing a computer to reallocate the recredited funds to an account associated with the services/products purchased.
